(19) United States
(12) Patent Application Publication
(10) Pub. No.: US 2007/0109969 A1
(43) Pub. Date: May 17, 2007

(54) Method of ensuring the quality of service in a network

(76) Inventors: Markus Baumeister, Aachen (DE); Guido Muesch, Linnich (DE)

Correspondence Address: PHILIPS INTELLECTUAL PROPERTY & STANDARDS, P.O. BOX 3001, BRIARCLIFF MANOR, NY, 10510, US

(21) Appl. No.: 10/552,050

(22) PCT Filed: Mar. 23, 2004
(86) PCT No.: PCT/IB04/01016

§ 371 Date: Oct. 9, 2006

(30) Foreign Application Priority Data
Apr. 7, 2003 (EP) 03100915.2

(51) Int. Cl. H04J 1/16

(52) U.S. Cl. 370/235

(57) ABSTRACT

The invention relates to a method of ensuring the quality of service in a broadcast network (1) which also comprises apparatuses (Q, Z) that do not have their own quality of service functionality. An apparatus operating as a bandwidth manager (BM) monitors the data traffic in the network and, in the case of risk of the ensured quality of service, it sends control messages (A) to the source (Q) of the data stream, which messages cause this source to reduce the data stream. The control messages (A) can be particularly transmitted through the simulated transmitter of the target (Z).

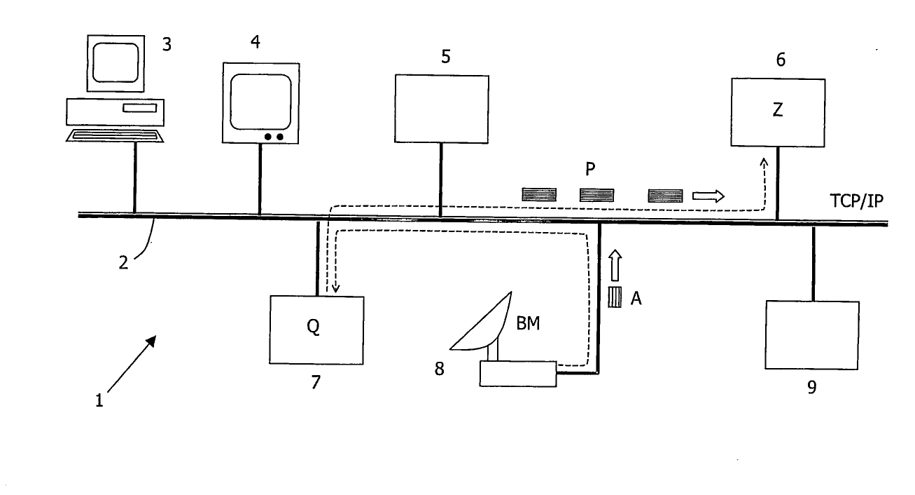

The invention relates to a method of ensuring the quality of service in a broadcast network, a network apparatus adapted to perform the method and a network including such an apparatus.

The connection of signal or data processing apparatuses in a network finds an increasingly wider application. This is the case, for example, in the medical world in which telemetry data of patients are radio-transmitted to monitors, and not least also in domestic apparatuses such as video and audio systems. The network hardware used for connecting the apparatuses provides a given maximum bandwidth for the communication between the apparatuses. Modem network apparatuses control specific functions with which the Quality of Service (QoS) is monitored and ensured in the network. Particularly, these apparatuses adapt their communication in such a way that there is no overload of the network. In this connection, for example, an apparatus for controlling the quality of service when combining a network having a guaranteed bandwidth and a network without a guaranteed bandwidth is known from US 2002/0141446 A1. All hitherto known systems for ensuring the service of quality have, however, in common that they require corresponding functionalities in the apparatuses communicating with each other or in special connection devices between different networks.

It is an object of the present invention to provide means for ensuring the quality of service in networks comprising network participants that do not perform their own control function of the quality of service.

This object is achieved by means of a method defined in claim 1, a network apparatus defined in claim 9 and a network defined in claim 10. Advantageous embodiments are defined in the dependent claims.

The method according to the invention is used for ensuring the quality of service in a broadcast network, i.e. a network in which the connected network participants disperse their data in such a way that all other network participants can receive them. By address characterization of the data, it can be ensured that these are used effectively by the desired target network participant only. The method comprises the following steps.
a) At least one of the network participants, in the function of source, transmits a data stream to at least one other network participant, in the function of target, without one of the two said network participants performing their own control of the quality of service in the network. The network participants may thus be particularly older and/or cheaper apparatuses such as, for example, video recorders, televisions, PCs or the like, in which no corresponding QoS functionality has (yet) been implemented.
b) A third network participant observes, in a function as bandwidth manager, the network traffic which is possible on the basis of the broadcast character of the network. In the case of a determined risk of overload of the network, the bandwidth manager transmits at least one control message (preferably a message normally used for controlling the data stream between the first two participants) to the previously mentioned source, wherein the control message causes the source to reduce the data stream transmitted to the previously mentioned target.

The method described thus provides the possibility of ensuring the quality of service in a broadcast network, also in cases when not all network participants can perform their own security function on this point. The bandwidth manager takes over the control function for such network participants. The bandwidth manager may be implemented in any other apparatus connected to the network. Furthermore, it is an advantage that the method can also be performed in networks which are self-contained, i.e. do not have any controllable transitions to other networks.

The data are exchanged in the network, preferably in a packet-oriented manner, for example, in accordance with a TCP/IP-based protocol. The protocol has known and effective mechanisms to regulate a data stream, for example, by means of the time interval between two transmitted confirmations (ACKs) or by given control packets.

In accordance with a preferred embodiment of the method, the bandwidth manager transmits the control messages to the source through the simulated or false transmitter of the target. The source thereupon assumes that the control message comes from the target. This simulation of a message from the target provides the possibility of utilizing feedback messages in conventional or older protocols for handling a data transfer so as to achieve the desired reduction of the data stream.

In the simplest case, the control message transmitted by the bandwidth manager may represent a direct request for reducing the data stream. A corresponding command (“ICMP Source Quench”) is provided in, for example, a TCP/IP protocol, wherein the bandwidth manager must, however, simulate the transmission of the message by the target.

Optionally, the bandwidth manager may also transmit a control message to the source, which control message simulates an erroneous transmission of the data stream from the source to the target, wherein the source is caused to reduce the transmitted data stream due to such an erroneous message and by internal protocol mechanisms (for example, Multiplicative Decrease and Linear Congestion Avoidance). This possibility can be particularly utilized when the previously mentioned direct request for reducing the data stream is not available or has not shown any effect.

Furthermore, the control message may also trigger a complete connection breakdown between the source and the target. Such a measure is usually only taken when less grave measures for reducing the data stream have not shown any result. Furthermore, the interrupted data stream should have a lower priority than other services run on the network.

In many cases, a plurality of data streams between different apparatuses will be simultaneously handled via the network. It may then also occur that this plurality includes data streams between apparatuses which do not have their own control of the quality of service in the network. In the simplest case, the bandwidth manager can then optionally select one of the last mentioned data streams in the case of a risk of overload so as to cause this data stream to be reduced. However, the bandwidth manager preferably provides a sequence of data streams in which these are reduced. Particularly, the largest data stream may come first, i.e. it will be reduced as the first data stream in the case of risk of overload.

The function of bandwidth manager is typically realized as an additional feature for conventional apparatuses in the field of, for example, consumer and medical electronics. It will therefore regularly occur that a plurality of network participants connected to a network can operate as bandwidth managers. To avoid conflicts or an intersecting reduction of data streams, the competences or tasks of the bandwidth managers are preferably coordinated.

The invention further relates to a network apparatus which is adapted to be capable of operating as a bandwidth manager in the sense of the method elucidated hereinbefore. This means that the network apparatus can observe the data traffic in a broadcast network, determine a threatening overload and, in this case, send a control message to the source of a data stream between two apparatuses, without their own service quality control, which causes the source to reduce the data stream. Advantageously, the network apparatus is implemented in such a way that it can also perform the variants of the method elucidated hereinbefore.

Furthermore, the invention relates to a network comprising network participants including at least one network apparatus of the type described hereinbefore, which can operate as a bandwidth manager. Such a network has the advantage, that not all connected network participants should be capable of independently monitoring their data traffic as regards ensuring the quality of service.

The invention will hereinafter be elucidated by means of the Figure. The sole Figure diagrammatically shows a network in which the method according to the invention can be carried into effect.

The network 1 shown in the Figure comprises a bus 2 with a plurality of apparatuses 3 to 9 connected thereto. The network 1 may be particularly a home network (IHDN: In-Home Digital Network) to which consumer electronics apparatuses such as, for example, satellite apparatuses 8, televisions 4, video recorders, PCs 3, audio apparatuses and the like are connected. A broadcast-based communication is performed in the network (for example, in accordance with IEEE 802.11, 10Base-2/10Base-3 Ethernet) in which isochrone data streams, i.e. audio or video data, can be transmitted.

Many modern network apparatuses have already a QoS functionality (Quality of Service) for ensuring the service of quality in the network. QoS provides given properties for a connection such as, for example, through-connection, latency time, transmission time fluctuations (jitter), etc. Some of these provisions may already be at risk due to a very low share of non-QoS traffic (for example, lower latency for a non-periodic current). In this case, non-QoS currents must be controlled down long before the bandwidth has been exhausted. Moreover, QoS schemes are known for use in WANs which are ensured by an input/output router of the core network (for example, RSVP, MPLS). These are not suitable for use in a sub-network such as, for example, a IHDN in which all connected apparatuses communicate via the same medium without interpositioning routers or switches. In so far as QoS schemes are further known for singular sub-networks (for example, IEEE 802.11 e), these cannot ensure QoS when there are apparatuses in the network which have not yet implemented the corresponding scheme.

For the reasons mentioned hereinbefore, there is currently no means for ensuring the quality of service in IHDN home networks in which modem and “older” apparatuses without a QoS functionality are present. The latter apparatuses are particularly CE apparatuses but also computers or apparatuses beyond the conventional standard. However, ensuring the quality of service in IHDNs for the user's acceptance of the transition from analog connected CE apparatuses to digitally connected apparatuses is of great significance. Without ensuring the quality of service, the apparatuses in a network could in fact attempt to transmit more data streams than is available in bandwidth, which would lead to spikes or artefacts in the end apparatuses (for example, TV or DVS), which the user would therefore experience as a deterioration as compared with analog systems.

In the solution according to the invention, described in greater detail hereinafter, the implementation of a QoS scheme is made possible in a network 1, although not all apparatuses 3 to 9 connected thereto have a QoS functionality. In this way, it will be possible to guarantee a great reliability of transmission in the network to the users, without the necessity that QoS apparatuses should already have found a complete breakthrough on the market. Said solution consists in that, in the broadcast-based network 1, one or more apparatuses 8 having a (conventional) QoS functionality have an additional functionality as bandwidth manager. The function of bandwidth manager involves constant listening in by the corresponding apparatuses to the data traffic in the network and thus determining the bandwidth load. When the load exceeds a predetermined threshold value, apparatuses that do not perform a QoS for their communication are “controlled down”, in that (false) control messages are sent to them, which in accordance with the communication standard used for the network, lead to a reduction of the transmission rate.

Referring to the Figure, the steps and components of a special embodiment for the solution described hereinbefore will now be elucidated. Accordingly, a network 1 according to the invention and its operation are characterized by the following features:
all network participants 3 to 9 are connected in the network 1 by means of a physical bus structure 2 so that each network participant can hear all messages. Preferably, at least two apparatuses, for example a PC 3 and a satellite apparatus 8m, implement an (arbitrary) QoS scheme.
moreover, one or more of said apparatuses (for example, the satellite apparatus 8 or the access point) implement the method according to the invention. If this method is implemented by a plurality of apparatuses, they should be co-ordinated so as to prevent repeated transmission of control messages. Subsequently, the apparatus performing the method is defined as the “bandwidth manager” BM.
at the start-up and in the case of changes in the network 1, the bandwidth manager BM determines which apparatuses work on a QoS scheme. In the simplest case, this is done by having these apparatuses report to it, also because it takes up a central role in the QoS method. Alternatively, the bandwidth manager BM may also pay attention to packets which are specific for the QoS protocol.
during operation, the bandwidth manager BM constantly monitors (in so far as it does not transmit data itself) the data streams in the network and thereby misses the used bandwidth. Additionally, it can also count collisions or retransmissions. Furthermore, the bandwidth manager may store source and target IP addresses of data streams between non-QoS apparatuses, particularly when these apparatuses have a high bandwidth load. Furthermore, the Internet headers as well as the first 64 data bits of a current packet or, in the simpler case, the first 64 bytes thereof should be stored. Said data streams are preferably sorted in accordance with their estimated bandwidth load. The bandwidth manager further determines (dependent on the QoS method used) a threshold value which can be assumed for non-QoS bandwidths.
if, on the basis of the criteria mentioned above, the available bandwidth seems to be exhausted, for example, because a threshold value of the bandwidth load has been exceeded, this cannot have been done, by definition, by the apparatuses performing a QoS. The bandwidth load of at least one non-QoS apparatus is thus beyond the load provided for non-isochronic traffic. The bandwidth manager BM thereupon selects one of the stored data streams. This can be effected either on the basis of said internal sorting, or (if the first 64 bytes of the packets have not been stored) that data stream of which a packet is transmitted as the next one. The selected data stream with the data packets P goes from the apparatus 7 operating as source Q to an apparatus 6 operating as target Z.
the bandwidth manager BM then transmits one or more “ICMP Source Quench” (RFC 792) packets to the source Q with the false sender address of the target Z and stores it. The bandwidth manager may need to access the TCP/IP stack for the simulation.

Said process is repeated for further data streams between non-QoS apparatuses until the expected new bandwidth load is below a second, lower threshold value. When the bandwidth load does not decrease, because, for example, the source Q ignores the “ICMP Source Quench” packet, the following further steps can be taken:
1. TCP connections have a false confirmation signal ACK of a packet already confirmed beforehand, which corresponds to a non-confirmation NACK of the next packet. The connections thereupon usually reduce their “sliding window” in accordance with RFC 2581, so that their bandwidth load decreases.
2. Other connections or TCP connections which also ignore the above-mentioned measures receive a false “ICMP Destination Unreachable Code 3” packet, which leads to a connection breakdown.
3. A false packet may also be sent by means of an ECN flow control (currently not widely spread) (ECN=Early Congestion Notification, RFC 3168).

A repeated transmission of the same packet to the same host can be prevented by means of a corresponding count by the bandwidth manager BM so as to avoid unnecessary bandwidth load. In switched networks without a physical bus structure, the method described above can be implemented in the switch as a bandwidth manager. In summary, the following advantages can be achieved with the method described:
a reliable quality of service in 802.11-based networks without all apparatuses in this network requiring their own QoS functionality;
independent of special QoS methods;
function in broadcast networks without additional hardware such as, for exarnple, switches;
connection breakdowns are avoided as much as possible;
particularly satisfactory function for TCP streams which have the highest interference potential due to burst-like data traffic (for example, ftp).

1. A method of ensuring the quality of service in a broadcast network (1), wherein
a) one network participant (7) as source (Q) transmits a data stream (P) to another network participant (6) as target (Z) without performing its own control of the quality of service;
b) a further network participant (8) observes, as a bandwidth manager (BM), the network traffic and, in the case of a risk of overload, transmits a control message (A) to the source (Q), which message causes this source to reduce said data stream (P).

2. A method as claimed in claim 1, characterized in that the data are exchanged in the network (1) in a packet-oriented manner, particularly in accordance with a TCP/IP-based protocol.

3. A method as claimed in claim 1, characterized in that the bandwidth manager (BM) transmits the control message (A) to the source (Q) through the simulated transmitter of the target (Z).

4. A method as claimed in claim 1, characterized in that the control message (A) represents a direct request for reducing the data stream.

5. A method as claimed in claim 1, characterized in that the control message (A) simulates an error in the transmission of the data stream (P) from the source (Q) to the target (Z), so that the source (Q) is made to reduce the data stream.

6. A method as claimed in claim 1, characterized in that the control message (A) triggers a connection breakdown.

7. A method as claimed in claim 1, characterized in that the bandwidth manager (BM) first attempts to reduce the largest data stream in view of a plurality of data streams between apparatuses without their own quality of service control in the case of risk of overload of the network (1).

8. A method as claimed in claim 1, characterized in that tasks between a plurality of network participants which can operate as bandwidth managers are co-ordinated.

9. A network apparatus (8), characterized in that it is adapted to be capable of operating as a bandwidth manager (BM) in a method as claimed in claim 1.

10. A network (1) comprising network participants (3 to 9) including at least one network apparatus (8) as claimed in claim 9.
